(19) United States
(12) Patent Application Publication
(10) Pub. No.: US 2016/0120301 A1
(43) Pub. Date: May 5, 2016

(54) Portable Cantilevered Table

(71) Applicants: Martin James Cross, Vancouver (CA); Brent R. Stebbings, Burnaby (CA)

(72) Inventors: Martin James Cross, Vancouver (CA); Brent R. Stebbings, Burnaby (CA)

(21) Appl. No.: 14/931,818

(22) Filed: Nov. 3, 2015

(30) Foreign Application Priority Data
Nov. 4, 2014 (CA) 2870698

(51) Int. Cl. A47B 13/00; H02J 7/35; A47B 13/16; A47B 37/00; A47B 5/02

(52) U.S. Cl. CPC A47B 13/003; A47B 37/00; A47B 5/02; A47B 13/16; H02J 7/355

(57) ABSTRACT

A portable cantilevered table comprises a tabular body 2; a fastening means 3 united with the distal end of the tabular body; and a stiffening wall 4 provided below the fastening means 3 at the distal end of the tabular body 2 and extending downward, substantially perpendicular to the bottom face of the tabular body 2. The fastening 3 means is adapted to engage with two upright rods A so as to inhibit vertical displacement and rotational movement of the tabular body 2, and the stiffening wall is adapted to be urged against the upright rods A when a load is present on the tabular body 2, so as to further inhibit vertical displacement and rotational movement of the tabular body 2

### CROSS-REFERENCE TO RELATED APPLICATIONS

This application claims priority to and the benefit of the patent application number 2,870,698 titled “Portable Cantilevered Table”, filed in the Canadian Intellectual Property Office on Nov. 4, 2014. The specification of the above referenced patent application is incorporated herein by reference in its entirety.

### TECHNICAL FIELD

This invention relates to a portable cantilevered table for attachment to at least two upright rods. More specially, it relates to a portable, free-standing cantilevered table, which is particularly suitable for attachment to the upright rods of handles in roll-aboard type luggage, and which is particularly suitable for temporarily placing and removing small relatively lightweight objects such as tabular electronic devices, beverages and food.

### RELATED ART

Roll-aboard type luggage is an increasingly popular form of hand luggage, generally consisting of a small suitcase or bag portion provided with two wheels on the bottom and a telescoping handle that can be extended so as to extend upward from the suitcase portion. In recent years, attempts have been made to unite tables or work surfaces with such luggage for use by passengers in waiting areas and the like. In addition to solutions in which the table is permanently united with the luggage and merely moves on a rigid support from a retracted position to a deployed position, such as that described in US 2012217109 A1, attempts have been made at providing portable tables that can be attached to, and detached from, the luggage at will.

As can be seen, for example, in U.S. Pat. No. 6,604,472 B2 and US 2012 227637 A1, one approach has been to rest the table directly on the top of the suitcase portion of the luggage, so that this suitcase portion bears the weight, and to hold the table in place, which is to say, prevent lateral and in-plane rotational displacement of the table, by engaging the table with the handle portion of the suitcase. This solution has several disadvantages. Firstly, the height of the table is limited to the height of the suitcase portion of the luggage. Additionally, because the surface of the suitcase portion is generally not flat, the table is likely to be tilted, or to rock, during use. Lastly, because there is little or no clearance between the table and the suitcase portion of the luggage, it is not possible to accommodate objects that pass through the table, such as beverages engaged in cutout beverage receptacles.

Another approach, which can be seen, for example, in U.S. Pat. No. 6,105,508 A and US 2010 187063 A1, is to mount the table on the uprights of the handle portion of the luggage, at a distance from the suitcase portion. This overcomes the disadvantages of the first approach described above. Problems have remained, however, in achieving a satisfactorily sturdy and rigid mount, such as would allow for practical use of the table. Tables of this sort can be seen as having an end that is closest to the user when in use, which herein will be referred to as the proximal end, and an end that is furthest from the user and will be referred to as the distal end. It is the distal end that attaches to the handle uprights. In the past, it has been hard to prevent this distal end from sliding downward under load. Another more difficult problem has been that of preventing the proximal end, which is the free end, from moving rotationally around a center or rotation in the vicinity of the distal end, which is to say, sagging. The known solutions can be broadly divided into those that are additionally supported from below by additional legs or rods, and those that rely on a rotational couple to urge two vertically staggered rods against opposite front and back sides of the handle uprights. It should be noted that, with the latter solution, an upward rotational movement of the proximal end of the table, such as may result upon removing a load, would reverse the rotational couple and thus separate the vertically staggered rods from the uprights, allowing the table to drop down suddenly. For this reason, the aforementioned patent applications state that an additional strap is required to maintain downward force on the proximal end and ensure the couple acts on the rods at all times.

Thus, all of these solutions rely of support from below, either by resting directly on the suitcase portion or by way of rods or legs, or rely on a strap attached to a point of support distant from both the table and the handle uprights. Accordingly, none of these solutions are freestanding on the handle uprights. This is a disadvantage in so much as such tables are difficult to mount and dismount. Such tables also lack in universality, as not all roll-aboard luggage will provide suitable points of support for the bottom of the table, or the legs, rods or straps that are used to steady the proximal end. Additionally, these legs, rods or straps limit the heights to which such tables can be adjusted.

### SUMMARY OF THE INVENTION

This invention provides a portable cantilevered table 1 comprising: a tabular body 2 having a top, a bottom, a proximal end and a distal end; a fastening means 3 united with the distal end of the tabular body; and a stiffening wall 4 provided below the fastening means 3 at the distal end of the tabular body 2 and extending downward, substantially perpendicular to the bottom face of the tabular body 2, wherein the fastening 3 means is adapted to engage with at least two upright rods A so as to inhibit vertical displacement of the tabular body 2 with respect to the upright rods A, which is to say displacement in the direction schematically indicated by the arrow i) in FIG. 1, and inhibit rotational movement of the tabular body 2 around a center of rotation approximately coinciding with the distal end thereof, which is to say displacement in the direction schematically indicated by the arrow ii) in FIG. 1, and wherein the stiffening wall is adapted to be urged against the upright rods A when a load is present on the tabular body 2, so as to further inhibit vertical displacement of the tabular body 2 with respect to the upright rods A and further inhibit rotational movement of the tabular body 2 around a center of rotation approximately coinciding with the distal end thereof.

By virtue of this configuration, when the table 1 is mounted on the upright rods A without a load having been placed on the tabular body 2, the table 1 will be held in place by the fastening means 3, and will not easily be displaced due to impacts, movement or the like which may occur in the non-loaded state. Furthermore, when a load is placed on the tabular body 2, a moment is produced which urges the stiffening wall 4 against the upright rods A, wherein not only does this stiffening wall prevent the proximal end of the tabular body 4 from sagging, but the resultant large area of pressing contact between the stiffening wall 4 and the upright rods A produces a strong frictional grip, which prevents slippage or skewing of the table 1.

The table of this invention is able to securely support loads such as beverages, food and electronic devices totaling several kilograms in weight without moving or sagging. Moreover, the table of this invention performs this function in a free-standing manner, which is to say mounted only on the upright rods, without relying on additional legs or straps. This makes the table of this invention easy to mount and dismount and provides complete freedom in terms of the height at which the table is mounted. What is more, the table remains securely mounted not only under load and when non-loaded, but also in the event of a slight lifting of the proximal end of the tabular body.

Here, the coefficient of static friction between the surface of the stiffening wall 4 that makes contact with the upright rods A and the surfaces of the upright rods A that make contact with the stiffening wall 4 is preferably greater than 0.5μₛ and more preferably greater than 1μₛ. In order to achieve this coefficient of static friction, the stiffening wall 4 may comprise a covering, texture or pattern on that face of the stiffening wall that faces the upright rods, which increases the coefficient of friction with the upright rods A.

In another aspect of this invention, the stiffening wall 4 is pivotable between the position at which said stiffening wall 4 extends downward, substantially perpendicular to the bottom face of the tabular body 2 and a second position at which said stiffening wall 4 extends horizontally, substantially in plane with the bottom face of the tabular body 2.

By virtue of this configuration, the table can be stored in a compact manner and, notably, can be folded flat, so that it can be stored in the outside pouch of a piece of roll-aboard luggage.

In a further aspect of this invention, the fastening means 3 comprises: a pressing member 11 having a crosspiece 12, which has a distal face and a proximal face, and which is arranged substantially parallel to the distal end of the tabular body 2 so that the proximal face thereof faces the distal end of the tabular body 2, and a slide piece 13 arranged perpendicular to the crosspiece 12, the slide piece 13 being slidably engaged in the tabular body 2 in such a way that the crosspiece 12 is mobile with respect to the tabular body 2, allowing the upright rods A to be trapped between the proximal face of the crosspiece 12 and the distal end of the tabular body 2; and a locking means 14 for locking the pressing member at least at one position relative to the tabular body.

In a variation of the aforementioned aspect, the fastening means 3 further comprises a biasing means for generating a biasing force between the upright rods A and the tabular body 2 or between the upright rods A and the crosspiece 12.

In another variation of the aforementioned aspect, the biasing means is an elastic biasing member 15 positioned between the proximal face of the crosspiece 12 and the distal end of the tabular body 2 so as to be elastically deformed when the locking means 14 is locked in said at least one position relative to the tabular body 2, such that a biasing force acts on the upright rods A.

The fastening means may further comprise a translational biasing means 17 for urging the pressing member 11 in a translational direction that increases the distance between the crosspiece 12 of the pressing member 11 and the tabular body 2, and a rotational biasing means 18 for urging the pressing member 11 in a rotational direction that increases the angle between the crosspiece 12 of the pressing member 11 and the tabular body 2.

In yet another aspect of this invention, the fastening means 3 comprises: first and second elongate notches 21, 22 provided in the vicinity of the distal end of the tabular body 2, respectively open on a first and a second side of the tabular body 2, and each having facing proximal and distal faces; and elastic biasing members 23, 24 positioned between the proximal and distal faces of the respective elongate notches so as to be elastically deformed when an upright rod A is present between the proximal and distal faces of the respective elongate notch, such that a biasing force acts on the upright rod A.

In a variation of the aforementioned aspect, the elastic biasing members 23, 24 comprise: a first upwardly inclined elastic biasing plate 23 having a fixed end and a free end, the fixed end being united with the bottom of the first elongate notch 21 and the free end being positioned above said fixed end; and a second downwardly inclined elastic biasing plate 24 having a fixed end and a free end, the fixed end being united with the top of the second elongate notch 22 and the free end being positioned below said fixed end.

The table of the invention may further comprise: a charging system 31 for a portable electronic device, which may in turn comprise a solar cell 32; and at least one sensor 41 capable of sensing the presence of an object on the table and outputting a signal indicating whether or not the object is present and an alarm means 42 capable of notifying a user when the output of the sensor 41 changes.

In an advantageous embodiment of the invention, a through hole 51 suitable for engaging a conical beverage container, and an elongate recess 61 suitable for engaging a tabular electronic device, are provided in the tabular body 2. Note that, when a conical beverage container such as a coffee cup is placed in a through hole and then removed, the tight fit between the container and the hole may result in a slight lifting force on the tabular body 2. Likewise, when a tabular electronic device such as a phone is removed from the elongate recess, it may catch on the sides of the recess and produce a lifting force. In this invention, because the engagement of the table with the upright rods by the fastening means does not depend on a rotational couple, the table will remain securely mounted, even if a lifting force is applied.

Thus, this invention provides a stable, compact, free-standing cantilevered table for mounting on upright rods, which can be mounted and dismounted rapidly and with great ease, and which can be folded flat so as to fit in the outside pouch of roll-aboard luggage.

### BRIEF DESCRIPTION OF THE DRAWINGS

FIG. 1 is an overall perspective view of the portable cantilevered table of the invention, mounted on the upright rods of a luggage handle;

FIG. 2 is a partially cutaway perspective view of the table shown in FIG. 1;

FIG. 3 is a partially cutaway plan view of a portion of the table shown in FIG. 1 including locking means;

FIG. 4 is a perspective view showing the stiffening wall and the tabular body, with the pressing member 11 removed;

FIG. 5 is a perspective view of the tabular body shown in FIG. 4, with the stiffening wall removed;

FIG. 6 is a perspective view of the table with the pressing member distanced from the tabular body and rotated into a position that facilitates mounting and dismounting;

FIG. 7 is perspective view of the pressing member in a second embodiment of the invention; and

FIG. 8 is a perspective view of a third embodiment of the portable cantilevered table of the invention.

### PREFERRED EMBODIMENTS

### First Embodiment

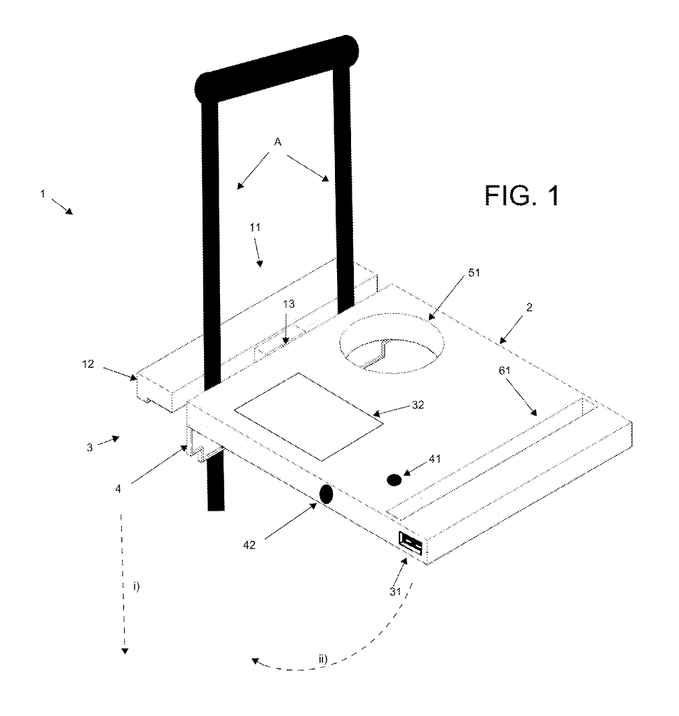

In a first preferred embodiment of this invention, illustrated by way of example in FIG. 1, the portable cantilevered table 1 of the invention is shown engaged on the two upright rods A of a piece of roll-aboard luggage, the suitcase portion of which is not illustrated. This table comprises a tabular body 2, the proximal end of which being the end that will be closest to the user when in use, and the distal end being that which will furthest away from the user, which is the end shown making contact with the upright rods A.

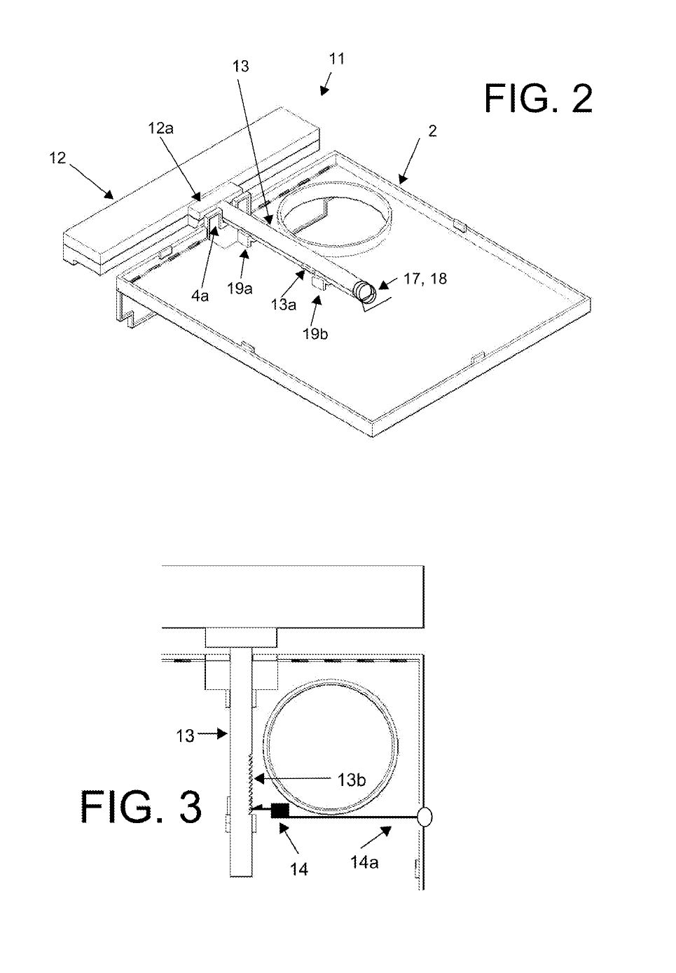

The fastening means 3 is provided at the distal end of the tabular body and, in this embodiment, comprises a pressing member 11 which is designed in an approximate T shape. As can be seen more clearly in the partially cutaway view in FIG. 2, the pressing member 11 comprises a crosspiece 12 and a slide piece 13, integrally united therewith. The slide piece 13 is received at the interior of the tabular body 2, guided in both translational and rotational movement by way of guide members 19a and 19b. In FIG. 2, only the lower guide members are shown, but mirror-form upper guide members are also provided above the slide piece 13.

FIG. 3 shows a schematic plan view of a key portion of the same embodiment in which a locking means 14, which in this case is a well-known spring-loaded pawl mechanism, engages with ratchet teeth 13b, which are provided on one side of the slide piece 13. A pushrod 14a cooperates with the pawl mechanism in a known manner so as retract the pawl from the ratchet teeth 13b when the pushrod is pushed from the exterior.

It will be readily appreciated that, by virtue of such a configuration, when the crosspiece 12 is pushed in the direction of the tabular body 2 so as to reduce the distance between the proximal face of the crosspiece 12 and the face at the distal end of the tabular body 2, the slide piece 13 will slide into the tabular body 2. At the same time, the inclined face of the pawl of the locking means 14 will be successively pushed aside by the inclined face of each tooth 13b until the peak of each tooth is reached, whereupon the pawl will be urged by the spring mechanism into the next valley between the teeth. In this valley between the teeth, the flat face of the tooth lies flush with the flat face of the pawl so that movement of the crosspiece in the direction that would increase the distance between the proximal face of the crosspiece 12 and the face at the distal end of the tabular body 2 is not possible. Consequently, if the upright rods A are present between the proximal face of the crosspiece 12 and the face at the distal end of the tabular body 2, and the crosspiece 12 is pushed in the direction of the tabular body until the crosspiece 12 is in close contact with the upright rods A and the upright rods A are in close contact with the distal end of the tabular body, the crosspiece will be locked in this position, and the upright rods A will be trapped therebetween, thus fastening the table in place, until such a time as the release pushrod 14a is pushed.

However, if the tabular body were to be mounted on the upright rods A with only a fastening means such as described above, the load bearing capacity of the table would be low. Notably, the proximal end of the tabular body would sag under heavy loads, which is to say that it would move downward along an arc having a center in the vicinity of the distal end of the tabular body. In this invention, this sagging movement is prevented by the stiffening wall 4.

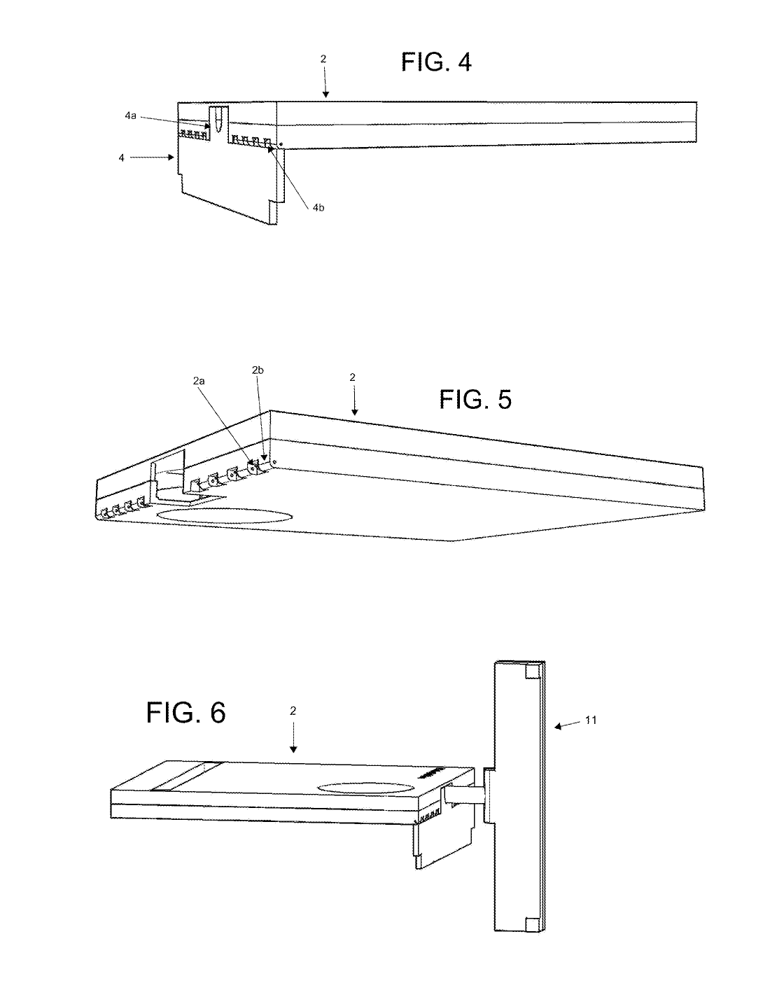

As shown in FIG. 4, the stiffening wall 4 extends downward, substantially in plane with the face of the distal end of the tabular body 2, and substantially perpendicular to the bottom face of the tabular body 2. Preferably, the stiffening wall 4 extends downward by no less than 10 mm, more preferably no less than 30 mm, and most preferably no less than 40 mm. In this embodiment, the stiffening wall 4 is adapted to pivot between the position depicted, which is to say the position at which it is substantially perpendicular to the bottom face of the tabular body, and a second position at which the stiffening wall 4 extends horizontally in the distal direction, substantially in plane with the bottom face of the tabular body 2, by a distance equal to the distance from the distal face of the crosspiece 12 to the distal end of the tabular body 2 when the pressing piece 11 is in a stowed position, allowing for compact storage of the table when not in use. This pivoting motion is achieved by way of a stop hinge which, as shown in FIG. 4 and FIG. 5 consists of recesses 2a in the tabular body 2, which receive mobile knuckles 4b on the stiffening wall 4, immobile knuckles 2b, which are integral with the tabular body 2, and a pin (not shown) which passes through the knuckles so as to unite the stiffening wall 4 with the tabular body 2. The shape of the recesses 2a is such that the rotational movement of the stiffening wall 4 is substantially limited to a 90° section of a circular arc such that, in the deployed position, the stiffening wall 4 cannot move in the proximal direction beyond perpendicular to the tabular body. A portion 4a of the stiffening wall 4 extends above the hinge and, as shown in FIG. 2, cooperates with a protrusion 12a on the crosspiece 12 of the pressing member 11 so that, when the pressing member 11 is pushed all the way against the distal end of the tabular body 2, the stiffening wall 4 will be pivoted into said second position.

The coefficient of static friction between the stiffening wall 4 and the upright rods A is preferably greater than 0.5μₛ and more preferably greater than 1μₛ. This may be achieved by choosing a suitable material for the stiffening wall itself, by producing a pattern or texture on the stiffening wall, or by covering the stiffening wall with a material having a high coefficient of friction, such as rubber.

When a load is placed on the tabular body 2, a moment is generated around a center of rotation substantially coinciding with the distal end of the tabular body 2. As a result, the force acting downward on the tabular body 2 is transmitted to the stiffening wall 4 so as to urge the stiffening wall 4 against the upright rods A. Thus, not only does the stiffening wall prevent the sagging motion described above, but the frictional engagement between the stiffening wall 4 and the uprights rods A prevents downward motion of the proximal end of the table 1 with respect to the upright rods A. The considerable contact area made possible by the stiffening wall results in a secure frictional hold against both downward slippage and skew. In practical tests, loads in excess of 2 kg could be stably supported with a configuration of this sort.

As described above, the locking means can be released by pressing the release pushrod 14a so as to retract the pawl from the teeth 13b. At this time, if a translational biasing means is provided, the pressing member 11 will be urged away from the tabular body and, if a rotational biasing means is provided, the pressing member 11 will also be rotated relative to the tabular body. The resulting configuration, which can be seen in FIG. 6, facilitates mounting and dismounting the table. In this embodiment, a single coil spring element 17, 18, which is rigidly united with the proximal end of the slide member 13 and with the tabular body 2, serves as both the translational biasing means 17 and the rotational biasing means 18. It is a matter of course, however, that the same effect could be produced by other means, including a helical groove on the slide piece 13 that cooperates with a projection within the tabular body 2, severing as the rotational biasing means 18.

### Second Embodiment

In order to more securely fasten the table 1 to the upright rods A with the fastening means 3, an elastic biasing force may be introduced so as to bias the fastening means 3 against the upright rods A or so as to bias the upright rods A against the distal end of the tabular body 2.

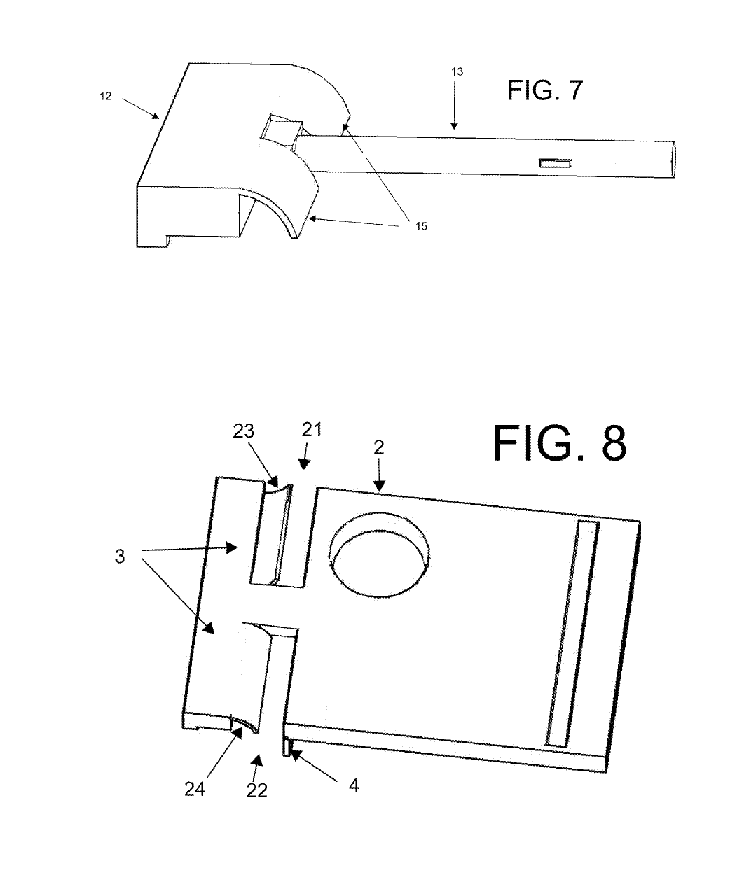

In a second preferred embodiment of the invention, as shown in FIG. 7, the elastic biasing force is introduced by way of downwardly inclined elastic biasing plates 15 which bias the upright rods A against the distal end of the tabular body 2 and the stiffening wall 4, when the pressing piece 11 is locked in place. These plates may be made of any strong elastic material, such as spring steel or rubber, but in this embodiment they are formed integrally with the crosspiece 12 from a resilient thermoplastic resin. Because the biasing plates 15 press against the upright rods A in a vertically asymmetrical manner, a slight moment is produced in the pressing member 11, and hence in the tabular body 2, which urges the stiffening wall 4 against the upright rods A, even when no load is present on the table, thus holding the table in place. Needless to say, a greater moment will be produced when a load is placed on the table.

### Third Embodiment

In a third embodiment of this invention shown in FIG. 8, the fastening means 3 comprises first and second elongate notches 21, 22, having square-U shapes, which are provided in the vicinity of the distal end of the tabular body 2. In the drawing, the notch 21 opens to the top of the figure and the notch 22 opens to the bottom of the figure. In the notch 21 a first upwardly inclined elastic biasing plate 23 is provided such that the fixed end is united with the bottom of the first elongate notch 21 and the free end is positioned above the fixed end. In the notch 22, a second downwardly inclined elastic biasing plate 24 is provided such that the fixed end is united with the top of the second elongate notch 22 and the free end is positioned below the fixed end.

By virtue of this configuration, the table 1 can be introduced sideways between two upright rods A so that the top face of the tabular body 2 faces the upright rod A on the left hand side and the bottom face of the tabular body 1 faces the upright rod A on the right side. From this position, the table 1 is rotated clockwise so that the upright rod A on the left enters the notch 22, deforming and overcoming the elastic resistance of the elastic biasing plate 24 as it does so, and the upright rod A on the right enters the notch 21, deforming and overcoming the elastic resistance of the elastic biasing plate 23 as it does so, until the table is substantially parallel with the ground and the perpendicular to the upright rods A. In this state, the elastically deformed elastic biasing plates 23, 24 urge the upright rods A against the distal faces on the proximal sides of the elongate notches, thus fastening the table in place. To dismount the table, it suffices to rotate the table a further approximately 90° in the clockwise direction, so as to disengage the upright rods A from the elongate notches 21, 22.

In order to adjust the height of a table configured in this manner relative to the upright rods A when mounted, it suffices to lift the proximal end of the tabular body slightly upwards, deforming and overcoming the elastic resistance of the elastic biasing plates 23, 24, so as to separate the stiffening wall 4 from the upright rods A. In this position, the minimal friction produced by the fastening means alone can easily be overcome, allowing the table 1 to be slid upward or downward along the upright rods A.

### Additional Variants

Various embodiments of this invention have been described in detail above, but this invention is not limited to the embodiments described here, and numerous variations and modifications will be apparent to those skilled in the art, without departing from the scope of the patent claims as set forth herebelow. For example, in the embodiments described above, the fastening means comprises a pressing member or elongate notches, but many other fastening means are contemplated within the scope of the present invention, including hooks, loops, straps, clips, screws and the like. Likewise, even in the case of a mobile pressing member such as described above, the shape of the pressing member is not limited to T-shapes, and the locking means is not limited to ratchet mechanisms. It is a matter of course that other locking means can also be employed, including a simple catch or latch.

In the foregoing embodiments, biasing force was introduced into the fastening means by way of elastic biasing plates, but this may be introduced in many other ways, such as by way of using elastic materials in the construction of some or all of the parts of the table, or by providing springs at specific locations, such as between the crosspiece and the slide piece.

Furthermore, a single continuous substantially planar stiffening wall is shown in the embodiments, but multiple or divided stiffening walls are possible, and the stiffening wall or walls may have various shapes, including those provided with recesses or protrusions for engaging the upright rods.

Use of the invention with the two upright rods of a luggage handle has been described, but the invention can be used with any plurality of upright rods. For example, the portable cantilevered table of the invention can be engaged on the bars of a child's crib, on the upright slats, posts or poles of an architectural feature, such as a fence or balcony railing, or any other grouping of upright rods, and the number of rods engaged can be any number greater than or equal to two.

We claim:

1: A portable cantilevered table comprising:
a tabular body having a top, a bottom, a proximal end and a distal end;
a fastening means united with the distal end of the tabular body; and
a stiffening wall provided below the fastening means at the distal end of the tabular body and extending downward, substantially perpendicular to the bottom face of the tabular body,
wherein the fastening means is adapted to engage with at least two upright rods so as to inhibit vertical displacement of the tabular body with respect to the upright rods and inhibit rotational movement of the tabular body around a center of rotation approximately coinciding with the distal end thereof, and
wherein the stiffening wall is adapted to be urged against the upright rods when a load is present on the tabular body, so as to further inhibit vertical displacement of the tabular body with respect to the upright rods and further inhibit rotational movement of the tabular body around a center of rotation approximately coinciding with the distal end thereof.

2: The table according to claim 1 wherein the coefficient of static friction between the surface of the stiffening wall that makes contact with the upright rods and the surfaces of the upright rods that make contact with the stiffening wall is greater than 0.5μₛ.

3: The table according to claim 1, wherein the stiffening wall further comprises one of a covering, a texture, a pattern on that face of the stiffening wall that faces the upright rods, which increases the coefficient of friction with the upright rods.

4: The table according to claim 1, wherein the stiffening wall is pivotable between the position at which said stiffening wall extends downward, substantially perpendicular to the bottom face of the tabular body and a second position at which said stiffening wall extends horizontally, substantially in plane with the bottom face of the tabular body.

5: The table according to claim 1, wherein the fastening means comprises:
a pressing member having a crosspiece, which has a distal face and a proximal face, and which is arranged substantially parallel to the distal end of the tabular body so that the proximal face thereof faces the distal end of the tabular body, and a slide piece arranged perpendicular to the crosspiece, the slide piece being slidably engaged in the tabular body in such a way that the crosspiece is mobile with respect to the tabular body, allowing the upright rods to be trapped between the proximal face of the crosspiece and the distal end of the tabular body; and
a locking means for locking the pressing member at least at one position relative to the tabular body.

6: The table according to claim 5, wherein the fastening means further comprises a biasing means for generating a biasing force between the upright rods and the tabular body or between the upright rods and the crosspiece.

7: The table according to claim 6, wherein the biasing means comprises an elastic biasing member positioned between the proximal face of the crosspiece and the distal end of the tabular body so as to be elastically deformed when the locking means is locked in said at least one position relative to the tabular body, such that a biasing force acts on the upright rods.

8. The table according to claim 5, wherein the fastening means further comprises a translational biasing means for urging the pressing member in a translational direction that increases the distance between the crosspiece of the pressing member and the tabular body, and a rotational biasing means for urging the pressing member in a rotational direction that increases the angle between the crosspiece of the pressing member and the tabular body.

9. The table according to claim 1, wherein the fastening means comprises:
first and second elongate notches provided in the vicinity of the distal end of the tabular body, respectively open on a first and a second side of the tabular body, and each having facing proximal and distal faces; and
elastic biasing members positioned between the proximal and distal faces of the respective elongate notches so as to be elastically deformed when an upright rod is present between the proximal and distal faces of the respective elongate notch, such that a biasing force acts on the upright rod.

10: The table according to claim 9, wherein the elastic biasing members comprise:
a first upwardly inclined elastic biasing plate having a fixed end and a free end, the fixed end being united with the bottom of the first elongate notch and the free end being positioned above said fixed end; and
a second downwardly inclined elastic biasing plate having a fixed end and a free end, the fixed end being united with the top of the second elongate notch and the free end being positioned below said fixed end.

11: The table according to claim 1, further comprising a charging system for a portable electronic device.

12: The table according to claim 11, wherein the charging system comprises a solar cell.

13: The table according to claim 1, further comprising:
at least one sensor capable of sensing the presence of an object on the table and outputting a signal indicating whether or not the object is present; and
an alarm means capable of notifying a user when the output of the sensor changes.

14: The table according to claim 1, further comprising a through hole suitable for engaging a conical beverage container.

15: The table according to claim 1, further comprising a recess suitable for engaging a tabular electronic device.

16: Use of the table according to claim 1 with luggage having a handle comprising two upright rods.
